(19) United States
(12) Patent Application Publication
(10) Pub. No.: US 2006/0218816 A1
(43) Pub. Date: Oct. 5, 2006

(54) Dryer heat modulation with solid state motor switch

(75) Inventor: Daniel F. Wunderlich, Newton, IA (US)

Correspondence Address: MCKEE, VOORHEES & SEASE, P.L.C.;ATTN: MAYTAG/ WHIRLPOOL, 801 GRAND AVENUE, SUITE 3200, DES MOINES, IA, 50309-2721, US

(73) Assignee: MAYTAG CORPORATION, Newton, IA (US)

(21) Appl. No.: 11/098,097

(22) Filed: Apr. 4, 2005

(51) Int. Cl. F26B 3/00; F26B 19/00

(52) U.S. Cl. 34/549; 34/482

(57) ABSTRACT

A method and apparatus for a clothes dryer that uses a solid state switching system to disconnect components of the dryer, such as the motor, when the dryer is not in use. The solid state switching system also modulates the output of a heater. Modulation of the heater is controlled by a timer associated with modulation logic, and/or other timers and thermostats.

### BACKGROUND OF THE INVENTION

Clothes dryers are generally well known. Traditionally, clothes dryers include a heater to dry laundry articles. The heater is controlled by timers and thermostats. Generally, the heater is turned on until a particular temperature is reached, at which point the thermostat causes the heater to be turned off. Once the particular temperature is below a particular point, the thermostat causes the heater to be turned on again. The timers are used to control the amount of time of the drying cycle.

It is a primary object, feature, or advantage of the present invention to improve upon the state of the art.

It is a further object, feature, or advantage of the present invention to provide a clothes dryer that is adapted to disconnect dryer components when the dryer is not in use.

Another object, feature, or advantage of the present invention is to provide a clothes dryer that is adapted to modulate the output of a heater.

These and/or other objects, features, or advantages of the present invention will become apparent from the specifications and claims that follow.

### SUMMARY OF THE INVENTION

The present invention relates to method and apparatus for a clothes dryer. More particularly, the present invention relates to a method and apparatus for a clothes dryer that uses solid state electronics for intelligent control to interrupt current flow when the dryer is not in use and to modulate the main heating element to thereby control the amount of heat in the dryer.

According to one aspect of the present invention, a clothes dryer is provided. The clothes dryer includes a housing, a heater disposed within the housing for output of heat to dry laundry articles, a motor disposed within the housing, and a cycling thermostat disposed within the housing for responding to temperature changes. There is also a solid state electronic switch disposed within the housing. The solid state electronic switch includes outputs electrically connected to the heater such that the solid state electronic switch is adapted to cycle the heater on and off to modulate the output of heat to dry the laundry articles, outputs electrically connected to the motor, and inputs electrically connected to a power source. The solid state electronic motor switch is adapted to disconnect at least the motor and the heater from the power source when the clothes dryer is not being used to dry laundry articles.

According to another aspect of the present invention, a method of controlling a clothes dryer is disclosed. The method includes providing a solid state electronic switch with outputs connected to a heater of the clothes dryer and a motor of the clothes dryer. The method further includes initiating a mode of operation for drying articles of laundry and then modulating output of heat of the heater by using the solid state electronic switch to cycle the heater on and off. The method further calls for completing the drying of the articles of laundry and then disconnecting the motor and the heater from a power source using the solid state electronic switch.

According to another aspect of the present invention, a method for drying articles of laundry is disclosed. The first step of the method is to provide a clothes dryer comprising a housing, a heater disposed within the housing for output of heat to dry laundry articles, a motor disposed within the housing, a cycling thermostat disposed within the housing for responding to temperature changes, and a solid state electronic switch disposed within the housing. The solid state switch includes outputs electrically connected to the heater such that the solid state electronic switch is adapted to cycle the heater on and off to modulate the output of heat to dry the laundry articles, outputs electrically connected to the motor, and inputs electrically connected to a power source. The solid state electronic switch is adapted to disconnect at least the motor and the heater from the power source when the clothes dryer is not being used to dry laundry articles.

### BRIEF DESCRIPTION OF THE DRAWINGS

FIG. 1 illustrates a view of one embodiment of a dryer of the present invention.

FIG. 2 is a diagram of one embodiment of an electrical system of the present invention.

### DETAILED DESCRIPTION OF A PREFERRED EMBODIMENT

The present invention is method and apparatus for a clothes dryer that uses a solid state system for two purposes. The first purpose is to disconnect power line connections to components of the clothes dryer when the clothes dryer is not in use. The second purpose is to modulate a heater to control the amount of heat in the dryer.

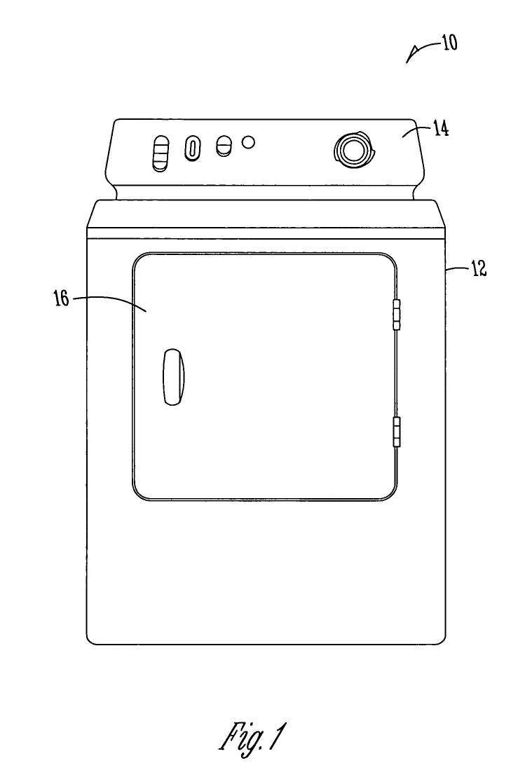

FIG. 1 illustrates a view of one embodiment of a dryer 10 according to the present invention. The dyer 10 includes a housing 12. A control panel 14 is shown which preferably includes a timer control. The dryer 10 has a door 16 for accessing the interior of the dryer for insertion and removal of laundry articles.

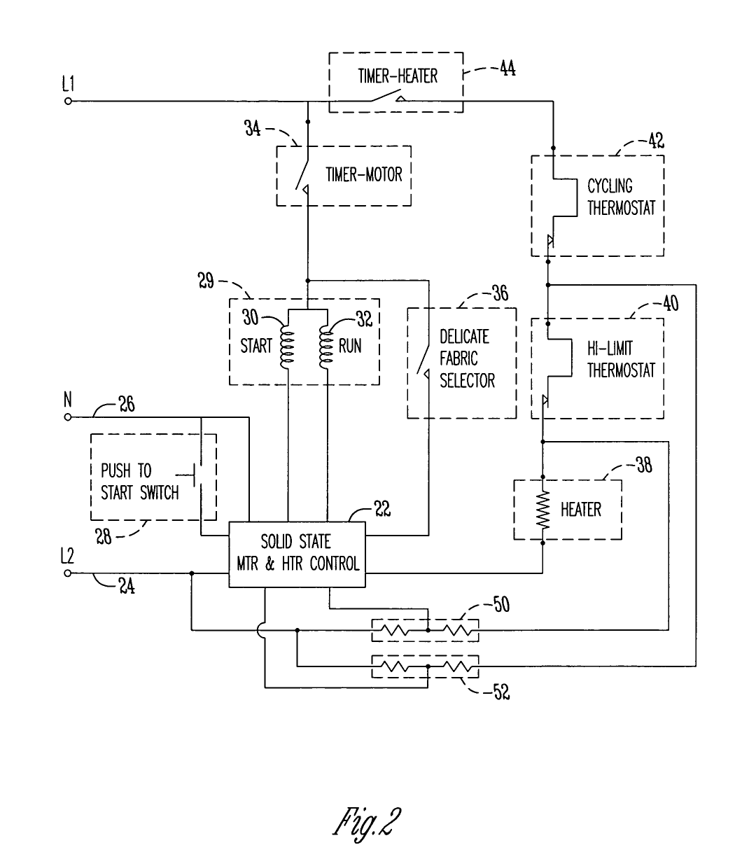

Within the housing 12 of the dryer 10 various dryer components are disposed. FIG. 2 provides an electrical diagram showing the relationship of several of these dryer components. The components include a motor 29 as well as a heater 38. Both the motor 29 and the heater 38 are electrically connected to a solid state motor and heater control 22. The solid state motor and heater control 22 has input connections for power lines. These input connections include an L2 connection 24 and a neutral connection 26. The solid state motor and heater control 22 provides for switching of the motor 29.

The solid state motor and heater control 22 is electrically connected to the start winding 30 and the run winding 32 of the motor 29. The solid state motor and heater control 22 is preferably but not necessarily incorporated within the motor assembly 29. The motor 29 drives a clothes drum and/or blower (not shown). There is a timer contact 34 associated with the motor 29.

The motor and heater control 22 has inputs from the cycling thermostat 42, hi-limit thermostat 40 and a delicate fabrics selection electrical contact 36. Each of these inputs initiates a modulation routine that is different in terms of heater power.

A start switch 28 is utilized to electrically connect neutral 26 to the solid state motor and heater control 22 for initiation of the drying cycle.

There is a cycling thermostat 42 and a hi-limit thermostat 40 that are operatively connected to the heater 38. The cycling thermostat 42, such as a bi-metal thermostat or thermistor, is exposed to the dryer exhaust air temperature. The cycling thermostat 42 is used to detect a temperature change thus that the heater 38 will remain on when voltage is applied until the temperature of the thermostat 42 rises above a particular temperature. Once this dryer temperature is reached, the thermostat 42 contacts open thereby disconnecting the heater 38 such that the laundry articles have an opportunity to cool. Once the temperature has dropped sufficiently, the heater 38 is again energized and this cycling is repeated.

The hi-limit thermostat 40 is physically disposed in the region of the heater 38 to control the temperature of the dryer inlet air. The hi-limit thermostat 40 is used to detect that particular temperature has been reached so that power can accordingly be removed from the heater 38 so that the laundry articles can cool. There is also a timer contact 44 associated with the heater which is used for switching on the heater 38. It is preferred that each timer (44, 34) is associated with a cam.

The present invention contemplates that proper modulation can result in various advantages, including power savings, decrease in dry times, reduced stress on laundry articles, and other advantages that may be associated with a particular manner of modulation.

A delicate fabric selection switch 36 is also electrically connected to the solid state heater and heater control 22.

It is to be understood that the present invention uses the solid state switching in multiple ways. First the solid state switching is used to disconnect clothes dryer components from the power source when the clothes dryer is not being used to dry laundry articles. This allows the dryer to comply with Underwriting Laboratories (UL) requirements. The present invention contemplates use in either an electric or gas type dryer. When used in an electric dryer, the solid state switch is used to break the L2 side of the power line. When used in a gas dryer, the solid state switch is used to break the neutral side of the power line when the dryer is not running.

Second, the present invention also uses the solid state switching to modulate the output of the heater. Instead of merely relying on a thermostat to cycle the heater on and off, the present invention provides for modulating the heater through a solid state switch. Thus, for example, through use of a solid state switch, the heater can be controlled during operation of the dryer. The heater is modulated in a number of ways. The modulation provided by the present invention contemplates a full range of conditions that range from full off of the heater to pulsing of the heater to provide a desired level of input conditions. Specifically, the initiation of hi-limit cycling could initiate modulation with the heater powered at 75% of maximum wattage. A delicate fabric selection could initiate modulation at 50% power. Further, initiation of cycling of the cycling thermostat could initiate modulation at 25% maximum wattage. Of course other wattage levels are contemplated.

Once again, the hi-limit 40 is disposed in the region of the heater 38 and is used to limit the temperature of the inlet air to the drum. When the thermostat 40 cycles, it is an indication that the airflow through the dryer 10 is low. This may be caused by restricted household ductwork, a lint filter that has not been cleaned, a very large clothes load, or some combination of the above. Modulation in this case seeks to keep the wattage as high as possible without causing further cycling of the thermostat. In this manner, the rate of drying can be maximized for the particular airflow conditions. Therefore, the initial modulation power level will be closer to maximum power. A further power adjustment downward can be made with subsequent cycles of the hi-limit thermostat until the balance is achieved.

In contrast, the cycling thermostat 42 is located downstream of the tumbler in the exhaust air stream. During the initial portions of the drying cycle, the moisture laden air keeps the air stream temperature suppressed. At the end of the run, when less moisture is in the air stream, the temperature of the exhaust air increases fairly rapidly. Once the cycling thermostat 42 begins cycling, a heater 38 operating at full wattage will cause fairly rapid repeat cycling. At this point in the drying cycle, a fairly low heater power level is sufficient to complete the drying process while avoiding subjecting the clothes to high air temperature.

A delicate fabrics selector 36 input by the user may indicate an entirely different modulation routine. This would provide a means to provide better control of the air temperature in the tumbler, while maintaining the relatively lower expense of the electro-mechanical system.

Further, the control can change from one modulation routine to another in later stages of the cycle. For instance, while using either of the hi-limit or the delicate fabrics modulation routines, the control may switch to the cycling thermostat routine when the cycling thermostat begins cycling.

With the above scheme, the intelligent motor and heater control must discern which thermostat has cycled. There is provided a couple voltage dividers 50, 52 to provide these inputs to the controller 22. While sketched external to the control 22, the voltage divider sensing circuits 50, 52 could be integral to the motor and heater control 22.

The term “heater” as used throughout is consistent with either an electric dryer or a gas dryer. It is to be understood, however, that in an electric type dryer, modulating a heater would preferably be performed by turning a heating element on and off. It is further to be understood that in a gas type dryer, modulating a heater would preferably be performed by regulating a gas valve associated with the dryer.

Therefore a method and apparatus for a clothes dryer that uses a solid state electronic switch to turn off dryer components when the dryer is not in use as well as modulate output of a heater has been disclosed. The present invention contemplates numerous variations and embodiments and is not to be limited to the preferred embodiment described herein. For example, the present invention contemplates variations in whether the dryer is an electric dryer or a gas dryer, variations in the modulation logic associated with a timer, variation in the manner in which thermostats, heater timers, and motor timers are used, and other variations within the spirit and scope of the invention.

What is claimed is:

1. A clothes dryer comprising:
a housing;
a heater disposed within the housing for output of heat to dry laundry articles;
a motor disposed within the housing;
a cycling thermostat disposed within the housing for responding to temperature changes;
a solid state electronic switch disposed within the housing and comprising:
(a) outputs electrically connected to the heater such that the solid state electronic switch is adapted to cycle the heater on and off to modulate the output of heat to dry the laundry articles;
(b) outputs electrically connected to the motor;
(c) inputs electrically connected to a power source;
(d) the solid state electronic motor switch adapted to disconnect at least the motor and the heater from the power source when the clothes dryer is not being used to dry laundry articles.

2. The clothes dryer of claim 1 further comprising a user input switch electrically connected to the solid state switch.

3. The clothes dryer of claim 1 further comprising a start switch electrically connected to the solid state switch.

4. The clothes dryer of claim 1 further comprising a high-limit thermostat electrically connected to the heater.

5. The clothes dryer of claim 1 wherein the solid state electronic switch modulates the heater based at least in part on the cycling thermostat.

6. The clothes dryer of claim 2 wherein the solid state electronic switch modulates the heater based at least in part on the user input switch.

7. The clothes dryer of claim 1 wherein the heater is a heating element and the dryer is an electric dryer.

8. The clothes dryer of claim 7 wherein the solid state switch is configured to break the power to the heater.

9. A method of controlling a clothes dryer, comprising:
providing a solid state electronic switch with outputs connected to a heater of the clothes dryer and a motor of the clothes dryer;
initiating a mode of operation for drying articles of laundry;
modulating output of heat of the heater by using the solid state electronic switch to cycle the heater on and off;
completing the drying of the articles of laundry;
disconnecting the motor and the heater from a power source using the solid state electronic switch.

10. The method of claim 9 wherein the step of modulating further includes receiving input from a user operated switch and accordingly modulating the output of heater.

11. The method of claim 9 wherein the step of initiating a mode operation occurs upon activation of a start switch.

12. The method of claim 9 further comprising monitoring temperature conditions using a cycling thermostat prior to the step of completing.

13. A method for drying articles of laundry, comprising:
providing a clothes dryer comprising a housing, a heater disposed within the housing for output of heat to dry laundry articles, a motor disposed within the housing, a cycling thermostat disposed within the housing for responding to temperature changes, a solid state electronic switch disposed within the housing and comprising
(a) outputs electrically connected to the heater such that the solid state electronic switch is adapted to cycle the heater on and off to modulate the output of heat to dry the laundry articles,
(b) outputs electrically connected to the motor,
(c) inputs electrically connected to a power source, and
(d) the solid state electronic motor switch adapted to disconnect at least the motor and the heater from the power source when the clothes dryer is not being used to dry laundry articles;
initiating a mode of operation for drying articles of laundry;
modulating output of heat of the heater by using the solid state electronic switch to cycle the heater on and off;
completing the drying of the articles of laundry;
disconnecting the motor and the heater from a power source using the solid state electronic switch.

14. The method of claim 13 wherein the step of modulating further includes receiving inputs from at least one thermostat and accordingly modulating the output of heater.

15. The method of claim 13 wherein the step of initiating a mode operation occurs upon activation of a start switch.

16. The method of claim 13 wherein the step of modulating further includes receiving an input from a user of the clothes dryer.

17. The method of claim 16 wherein the input corresponds to a fabric selection.
